(19) United States
(12) Patent Application Publication
(10) Pub. No.: US 2014/0279217 A1
(43) Pub. Date: Sep. 18, 2014

(54) HOUSEHOLD INVENTORY MANAGEMENT AND SHOPPING LIST GENERATION

(71) Applicant: NETGEAR, Inc., San Jose, CA (US)

(72) Inventor: Tim Stover, Morgan Hill, CA (US)

(73) Assignee: NETGEAR, Inc., San Jose, CA (US)

(21) Appl. No.: 14/212,446

(22) Filed: Mar. 14, 2014

Related U.S. Application Data
(60) Provisional application No. 61/793,329, filed on Mar. 15, 2013.

(51) Int. Cl. G06Q 30/06

(52) U.S. Cl. CPC G06Q 30/0633
USPC 705/26.8

(57) ABSTRACT

An exemplary method for managing household inventory and generating an automatically updated shopping list comprises receiving a message transmitted from a store including purchased item information from the store, organizing and storing the information in a database, obtaining captured information relating to consumed purchase items, updating the database based on the captured information, generating a shopping list on demand by a user based on updated data in the database and predetermined inventory threshold levels and wirelessly transmitting the shopping list to the user.

### CROSS-REFERENCE TO RELATED APPLICATION

This application is a non-provisional application claiming priority from U.S. Provisional application No. 61/793,329 previously filed with the USPTO on Mar. 15, 2013. The entirety of the prior application is incorporated by reference herein.

### BACKGROUND

Imperfect memory recall is a common human weakness. While in a store on a shopping trip, many of us have had the experience of having difficulty recalling items that need to be purchased. As a result, fewer, wrong, or excessive items may be purchased. Frequently, the one item that necessitated the shopping trip will be the item forgotten while in the store. Thus, another trip to the store will be necessary.

Traditionally, a hand-written shopping list may be produced each time prior to shopping. Such a hand-written shopping list may be used during shopping to alleviate the recall problem. However, hand-written lists may be incomplete, lost, or forgotten. Thus, one may end up in the same situation as before a list was composed.

Many handheld computing devices (e.g., smart phones) now have the capability of hosting software that can create a shopping list for a user. Typically, these types of digital shopping lists are created and maintained by the user. For example, a user can enter the items needed in a digital text format, thereby creating a digital version of the hand-written shopping list. Assuming the user is more likely to have her phone with her when she goes on a shopping trip, the user is more likely to have access to the digital shopping list. However, this type of digital shopping lists still has the disadvantage of being potentially incomplete because their accuracy depends on the user's memory regarding missing or depleted items in the household inventory. Furthermore, this type of digital shopping lists is tedious to create because they require user vigilance to monitor her household inventory and to assiduously enter the information into a hand-held device prior to shopping.

Thus, a market exists for a household inventory management system that is also capable of generating easily accessible and dynamically updated shopping lists.

### SUMMARY

An exemplary method for managing household inventory and generating an automatically updated shopping list comprises receiving a message transmitted from a store including purchased item information from the store, organizing and storing the information in a database, obtaining captured information relating to consumed purchase items, updating the database based on the captured information, generating a shopping list on demand by a user based on updated data in the database and predetermined inventory threshold levels and wirelessly transmitting the shopping list to the user.

Other exemplary embodiments and implementations are disclosed herein.

### BRIEF DESCRIPTION OF THE FIGURES

FIG. 1 illustrates an exemplary network communications system.

FIG. 2 illustrates an exemplary process for monitoring inventory and generating an updated shopping list.

FIG. 3 illustrates an exemplary gateway.

FIG. 4 illustrates an exemplary process for updating the inventory database with purchased items.

FIG. 5 illustrates an exemplary process for updating the inventory database with consumed items.

FIG. 6 illustrates an exemplary process for enhancing a user's shopping experience.

### DETAILED DESCRIPTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown or described, but is to be accorded the widest scope consistent with the principles and features disclosed herein.

FIG. 1 illustrates an exemplary network communications system 100. The system 100 includes a communications network 110, such as the Internet. Various exemplary components are shown to be connected to each other via the communications network 110. These exemplary components include an inventory monitoring server 120, a database 130, a gateway 140, and stores 170. The gateway 140 is also connected to a personal computer (PC) 150 and an identifier reader 160. Many more components may be connected to the communications network 110. The system illustrated in FIG. 1 is simplified for ease of explanation purposes. For example, multiple additional servers, databases, stores and gateways can be connected to the network 110 and are not shown in the figure.

The inventory monitoring server 120 is a server computer providing inventory monitoring services to one or more client computers, such as the PC 150. In general, a server is a computer hardware system dedicated to running one or more services, as a host, to serve the needs of users of other computers on a network. Servers often provide essential services across a network, either to private users inside a large organization or to public users via the Internet. While nearly any personal computer is capable of acting as a network server, a dedicated server generally may include features making it more suitable for demanding service environments. These features may include a faster CPU, increased high-performance RAM, and increased storage capacity in the form of a larger or multiple hard drives, and so forth. Servers also typically have fault tolerant features, such as redundancy in power supplies, storage, and network connections. In an exemplary implementation, the inventory monitoring server 120 monitors and updates household inventories for multiple users via their respective computing devices (e.g., the PC 150) and gateways 140. The inventory monitoring server 120 updates a database 130, which may be locally or remotely accessible via a local network (not shown) and/or the communications network 110.

The database 130 can be implemented as a remote database (as shown), within a server 120 (not shown), or within a user device (e.g., PC 150) (not shown), or may be distributed over multiple storage devices. In an exemplary implementation, the database 130 stores household inventory data of one or more users.

The gateway 140 includes at least a modem for communicating with the communications network 110 and a router for performing routing functions well known in the art. An exemplary gateway 140 is illustrated in FIG. 3 and will be discussed in more detail below.

The PC 150 is shown for illustration purposes. One skilled in the art will appreciate that any user computing device (e.g., a laptop computer, a digital tablet, a digital handheld device, etc.) capable of performing the inventory management and shopping list generation processes described herein may be represented by the PC 150. Components and functions relevant to this invention in the PC 150 and identifier reader 160 will be described in more detail below.

The stores 170 represent a plurality of participating stores that will benefit from the inventorying monitoring and management processes disclosed herein. The stores 170 may be any of traditional brick and mortar stores, warehouse stores, online retailers, and/or any other type of inventory provider that tracks user purchases and can communicate purchased item information to users.

In an exemplary implementation, a user may elect to have the inventory management server 120 manage household inventory such as groceries or other consumables. For instance, a user may sign up via the PC 150 through a user interface presented by a web browser. The user interface is provided by the inventory management server 120. During the sign-up process, the user may be prompted to categorize the inventory. The user may choose to use a default categorization. The user may also be prompted to indicate a threshold level for each item or category of items or may elect to use default threshold levels. Threshold levels indicate when a user needs to replenish different items or categories of items. In an exemplary implementation, the user may be prompted to further personalize or customize the inventory management schema most suitable for her household depending on design choice.

Stores may also sign up to participate in the inventory management system. Stores can benefit from participation for at least two reasons. First, participating stores may enjoy improved customer loyalty by assisting customers to achieve a more accurate inventory on products purchased from the stores. Second, participating stores can benefit by increased sales when customers replenish depleted items in the household inventory.

In an exemplary implementation, when a user shops at a participating store, the store captures information relating to the purchased items during checkout. Information relating to the purchased items can be captured using conventional cashier scanning devices that capture the barcode, SKU, or other identifiers. After the user pays for the items, the participating store can automatically send information regarding the purchased items to the inventory monitoring server 120. The inventory monitoring server 120 updates the database 130 which stores the user's household inventory with the information relating to the purchased items. Thus, the user does not need to manually enter the information relating to the purchased items to update the user's inventory database.

Later, as each purchased item is consumed, the user can scan the container of the consumed item at an identifier reader 160 before discarding the container. The identifier reader 160 can be located near a trash can and/or recycle bin for easy scanning. In an exemplary implementation, the identifier reader 160 is capable of reading barcodes, UPC, the SKU, and/or any other suitable identifier. In one implementation, the identifier reader 160 wirelessly sends the scanned identifier and other relevant captured information to the PC 150. The PC 150 then can either update a local inventory database and/or can send the information to the inventory monitoring server 120 via the gateway 140 and communications network 110. In an exemplary implementation, the inventory monitoring server 120 updates the database 130 with the depletion of the consumed item.

When the user again returns to a participating store, a shopping list can be automatically generated on demand by the user based on the updated information in the database 130 and inventory threshold levels, if any. If the inventory database 130 resides locally, entirely or partially, in the PC 150, the inventory monitoring server 120 can access the information through the communications network 110 and the gateway 140. The updated shopping list can be displayed on the user's handheld device. In addition, a map of the store indicating the aisles where items on the shopping list are located may also be displayed to the user. This way, an updated shopping list is always ready as needed with very minimal effort on the part of the user to create and update the inventory that forms the basis of the list.

FIG. 2 illustrates an exemplary process for automatically monitoring and updating a household inventory and generating a shopping list based on the updated inventory. In an exemplary implementation, the process steps of FIG. 2 are performed by the inventory monitoring server 120. However, a person skilled in the art will recognize that these process steps can likewise be implemented in a local computer system (e.g., a PC 150, a laptop, the gateway 140, or any other suitable computing device), and/or in a distributed computing environment over a communications network.

At step 210, information relating to purchased items is obtained. In an exemplary implementation, a participating store sends an email or a data file to the inventory monitoring server 120. The email or data file identifies the user who has just made a purchase at a participating store. The email or data file also includes information relating to items that have been purchased. The information includes one or more of the following relating to each purchased item, without limitation: quantity, brand, expiration date, size, quality, flavor, color, etc. The inventory monitoring server 120 parses the email or data file to determine the items purchased by the user. At step 220, the purchased item information is organized and stored on the database 130 to update the user's household inventory.

At step 230, after a user has consumed an item, information relating to the consumed item is obtained. In an exemplary implementation, the information relating to the consumed item is captured by an identifier reader 160. For instance, the identifier reader 160 may be strategically placed near a trash can or a recycling bin to make it easier for a user to scan it's barcode, UPC code, or any other suitable identifier using the identifier reader 160. In an exemplary implementation, the identifier reader 160 sends the consumed item's identifier (and any other relevant information) wirelessly to the PC 150. In an exemplary implementation, the PC 150 updates household inventory data in a local database. In another exemplary implementation, the PC 150 forwards the captured information to the inventory monitoring server 120 through the gateway 140 and the communications network 110.

At step 240, the inventory monitoring server 120 updates the user's household inventory stored in the database 130 based on the captured consumed item information.

At step 250, when a user goes on the next shopping trip, the inventory monitoring server 120 can generate an up-to-date shopping list on demand based on the updated household inventory information in the database 130. The shopping list indicates up-to-date information regarding the user's household inventory because information relating to previously purchased items and consumed items have been used to update the user's household inventory stored on the database 130. If the database resides locally to the PC 150, the inventory monitoring server 120 can access the database via the communications network 110 and the gateway 140.

At step 260, the shopping list is wirelessly transmitted to the user. The inventory monitoring server 120 sends the shopping list via the communications network 110. In an exemplary implementation, the user can access the shopping list using a handheld device (e.g., a smart phone) and through any available wireless network (e.g., 3G, 4G, WiFi, etc.) connected to the communications network 110.

In an exemplary implementation, the inventory monitoring server 120 may additionally send a map of the store currently being visited by the user. The map may include a visual display of aisle(s) containing items the user may need to purchase based on the shopping list. The map can improve user's efficiency to quickly locate items that need to be purchased.

FIG. 3 illustrates an exemplary gateway that has the capability of facilitating household inventory management. The gateway 140 includes a modem 310, a router 320, a processor 330, a memory 340, and a user interface 360. The functions of the modem 310 and router 320 in a gateway 140 for facilitating the connections to the communications network 110, such as the Internet, are well known in the art and need not be described in more detail herein. Likewise, the user interface 360 is known in the art for obtaining input from and providing output to a user computing device, such as the PC 150 and need not be described in more detail herein.

In an exemplary implementation, the gateway 140 also includes a processor 330 for executing instructions stored in the memory 340 for facilitating household inventory management. In one implementation, the memory 340 includes an inventory monitoring module 350, which may be implemented entirely in software, firmware, hardware, or a combination thereof. In a software implementation, the inventory monitoring module 350 includes computer instructions executable by the processor 330 to facilitate the management of household inventory. In this implementation, the gateway 140 may be configured to communicate with the PC 150 for storing inventory data on a local database accessible to the PC 150. In the alternative or in combination, the gateway 140 may be configured to communicate with the server 120 for storing part or all of the inventory data on the remote database 130. The actual inventory data storage and access implementations depend on design choice and do not affect the spirit of this invention.

In an alternative implementation, the gateway 140 may include conventional gateway components without the ability to specifically facilitate household inventory management. In this implementation, a PC 150 or another computing device may be configured to include an inventory monitoring module 350 and a processor for executing software instructions of the inventory monitoring module 350. In this implementation, the PC 150 may use a local database for storing inventory data. Alternatively or in combination, part or all of the inventory data may be stored on the remote database 130 accessible by the server 120. If inventory data is solely stored on a local database, the server 120 is enabled to access the database via the communications network 110, the gateway 140 and the PC 150. The actual inventory data storage and access implementations depend on design choice and do not affect the spirit of this invention.

In yet another alternative implementation, the inventory monitoring module 350 may reside in a server computer (e.g., the inventory monitoring server 120) connected to the communications network 110. In this implementation, the gateway 140 and the PC 150 may not include any specialized software or hardware but have the capability of connecting to the server 120 via the communications network 110 such as the Internet. For instance, the PC 150 may include a web browser enabling a user to access inventory management services provided by the server 120 via a user interface webpage maintained by the server 120. The server 120 may cause information to be obtained from both the participating stores and the identifier reader 160 to effectively update the user's household inventory and generate updated shopping lists.

Exemplary methods for facilitating household inventory management and generating updated shopping lists (e.g., performed by the inventory management module 350), applicable in any combination of the above exemplary implementations, will be described below with reference to FIGS. 4, 5 and 6.

FIG. 4 illustrates an exemplary process for obtaining purchased item information to update the inventory database (e.g., the remote database 130 and/or a local database accessible to the PC 150 and gateway 140). When a user shops at a participating store 170, the user can benefit from an automatic update of purchased items in her household inventory database.

At step 410, a data file or email from a participating store is obtained. The data file or email includes information relating to items purchased by a user at a participating store. In an exemplary implementation, the store sends the data file or email to one or more of the server 120, gateway 140, or PC 150 depending on the specific implementation.

At step 420, the data file or email is parsed to determine the information relating to the purchased items. In an exemplary implementation, information relating to each purchased item (e.g., the UPC code, the SKU, quantity, brand, size, type, expiration date, and/or other information) is extracted from the data file or email.

At step 430, the information relating to each purchased item is categorized and organized. For example, for food items, the items may be categorized by type, such as meat, vegetables, dairy, bread, drinks, etc. In an exemplary implementation, information is categorized based on user customized preferences. In another exemplary implementation, information is categorized based on default categorization.

At step 440, the user's inventory database is updated. Appropriate categories in the database are updated based on the organization.

FIG. 5 illustrates an exemplary process for obtaining consumed items information to update the user's inventory database. When a user finishes consuming a product and is ready to discard the container, the user may scan an identifier on the container (e.g., a barcode, the UPC or the SKU, etc.) at the identifier reader 160. The identifier reader 160 can be strategically placed near a trash can or recycle bin to make the process easier for the user.

At step 510, an identifier is wirelessly sent from the identifier reader 160 to one or more of the server 120, gateway 140, and/or PC 150 depending on the specific implementation.

At step 520, whether the identifier is for an incoming item or an outgoing item is determined. In an exemplary implementation, the identifier reader 160 may have two settings to allow a user the choice of scanning incoming items purchased at non-participating stores or scanning outgoing consumed items. Whether an identifier is for an incoming or outgoing item will be indicated in the identifier information being wirelessly transferred.

At step 530, the user's inventory database is updated accordingly. If the received identifier is for an incoming purchased item, the appropriate category in the household inventory is incremented. If the received identifier is for a consumed outgoing item, the appropriate category in the household inventory is decremented.

FIG. 6 illustrates an exemplary process of a user shopping at a participating store.

At step 610, a user arrives at a participating store.

At step 620, the user accesses a shopping list on a handheld device (e.g., a smart phone). In an exemplary implementation, the smart phone may include a software application enabling it to communicate with the inventory monitoring server 120 or the gateway 140, depending on implementation. For example, using the software application, the user can request the server 120 to generate and send an updated shopping list. The user's device is connected to the server 120 via any available wireless network well known in the art (e.g., WiFi, 3G, 4G, etc.). As a result, the user can view an updated shopping list generated on demand based on the user's current household inventory. The shopping list may be displayed in any format or digital views (e.g., user-defined, default, etc.).

In an exemplary implementation, the shopping list generated displays only items available at the participating store that the user is currently visiting. In an alternative implementation, the shopping list may highlight or otherwise indicate items that are available at the current store. This way, the user has access to a helpful and accurate shopping list while visiting each participating store.

At step 630, the user can also access a store map indicating the location, price, or other information relating to items on the shopping list. For example, the server 120 may perform a price comparison on the user's behalf and indicate to the user whether the current store has the lowest price for one or more items on the shopping list. The example is only illustrative. Of course, the server 120 may perform other data analysis not specifically disclosed herein for further facilitating the user's shopping experience (e.g., indicate sales at one or more participating stores, rank stores by distance, etc.).

Thus, the user's shopping experience and efficiency are greatly improved and the participating stores can virtually effortlessly increase customer loyalty and sales.

One skilled in the art will recognize that the exemplary processes illustrated above are merely illustrative. Other combinations of process steps may be implemented depending on specific implementation.

The program environment in which a present embodiment of the invention is executed illustratively incorporates a general-purpose computer or a special purpose device such as a hand-held computer. Details of such devices (e.g., processor, memory, data storage, display) may be omitted for the sake of clarity.

It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM), non-volatile (e.g., ROM, disk) memory, and/or other media.

The foregoing embodiments of the invention have been presented for purposes of illustration and description only. They are not intended to be exhaustive or to limit the invention to the forms disclosed. Accordingly, the scope of the invention is defined by the appended claims, not the preceding disclosure.

What is claimed is:

1. A computer-implemented method for managing household inventory and generating an automatically updated shopping list, comprising:
(a) receiving a message transmitted from a store including purchased item information from the store;
(b) organizing and storing the purchased item information in a database;
(c) obtaining captured information relating to consumed purchase items;
(d) updating the database based on the captured information;
(e) generating a shopping list on demand by a user based on updated data in the database and predetermined inventory threshold levels; and
(f) wirelessly transmitting the shopping list to the user.

2. The method of claim 1, wherein receiving a message transmitted from a store includes receiving a data file from the store.

3. The method of claim 1, wherein receiving a message transmitted from a store includes receiving an email from the store.

4. The method of claim 1, wherein said organizing and storing includes categorizing the purchased item information into pre-defined categories.

5. The method of claim 4, wherein said pre-defined categories include user-defined categories.

6. The method of claim 1, wherein said organizing and storing includes validating the data obtained.

7. The method of claim 1, wherein said organizing and storing includes implementing a user-defined database schema.

8. A non-transitory computer-readable medium comprising logic instructions executable by a computing device for managing household inventory and generating an automatically updated shopping list, said logic instructions, when executed:
(a) receiving a message transmitted from a store including purchased item information from the store;
(b) organize and store the purchased item information in a database;
(c) obtain captured information relating to consumed purchase items;
(d) update the database based on the captured information;
(e) generate a shopping list on demand by a user based on updated data in the database and predetermined inventory threshold levels; and
(f) wirelessly transmit the shopping list to the user.

9. The computer-readable medium of claim 8, wherein said store automatically sends the purchase item information each time a user makes a purchase in the store.

10. The computer-readable medium of claim 8, wherein said organize and store includes categorizing the purchased item information into pre-defined categories.

11. The computer-readable medium of claim 8, wherein said obtain captured information includes receiving a barcode transmitted from an identifier reader.

12. The computer-readable medium of claim 8, wherein said predetermined inventory threshold levels were defined by the user.

13. The computer-readable medium of claim 8, wherein said predetermined inventory threshold levels were default levels.

14. The computer-readable medium of claim 8, wherein said generate includes generating the shopping list that can be displayed in any one of multiple digital views.

15. The computer-readable medium of claim 8, further comprising instructions that, when executed, wirelessly transmit a store map to the user.

16. An inventory monitoring server for managing household inventory and generating an automatically updated shopping list, comprising:
a computer processor; and
a computer memory storing instructions that when executed:
(a) receiving a message transmitted from a store including purchased item information from the store;
(b) organize and store the purchased item information in a database;
(c) obtain captured information relating to consumed purchase items;
(d) update the database based on the captured information;
(e) generate a shopping list on demand by a user based on updated data in the database and predetermined inventory threshold levels; and
(f) wirelessly transmit the shopping list to the user.

17. The server of claim 16, wherein said store automatically sends the purchase item information each time a user makes a purchase in the store.

18. The server of claim 16, wherein said organize and store includes categorizing the purchased item information into pre-defined categories.

19. The server of claim 16, wherein said predetermined inventory threshold levels were defined by the user.

20. The server of claim 16, further comprising instructions that, when executed, wirelessly transmit a store map to the user.
